(19) United States
(12) Patent Application Publication
(10) Pub. No.: US 2011/0069190 A1
(43) Pub. Date: Mar. 24, 2011

(54) FAST FOCUSING METHOD FOR DIGITAL CAMERA

(75) Inventors: Chan-Min Chou, Taipei County (TW); Chia-Lun Tsai, Changhua County (TW); Chih-Pin Yen, Taipei County (TW)

(73) Assignee: ALTEK CORPORATION, Hsinchu (TW)

(21) Appl. No.: 12/772,571

(22) Filed: May 3, 2010

(30) Foreign Application Priority Data
Sep. 18, 2009 (TW) 098131644

(51) Int. Cl. H04N 5/228

(52) U.S. Cl. 348/222.1; 348/E05.031

(57) ABSTRACT

A fast focusing method for a digital camera is applied in the digital camera to judge whether a focusing focal length of the digital camera needs to be adjusted in an auto focusing stage. The fast focusing method includes capturing a target image at a reference focal length; performing a blur detection procedure on the target image to acquire a focus value; setting a focusing focal length range covering the reference focal length when the focus value is between a lower limit focusing threshold and an upper limit focusing threshold; capturing corresponding comparison images at different focusing focal lengths respectively in the focusing focal length range; calculating a contrast value of each comparison image; and calculating the contrast values and a target focal length through a quadratic curve approximation method, and adjusting lenses of the digital camera to the set target focal length to perform shooting.

### CROSS-REFERENCE TO RELATED APPLICATIONS

This non-provisional application claims priority under 35 U.S.C. §119(a) on Patent Application No(s). 098131644 filed in Taiwan, R.O.C. on Sep. 18, 2009 the entire contents of which are hereby incorporated by reference.

### BACKGROUND OF THE INVENTION

1. Field of Invention

The present invention relates to a focusing method, and more particularly to a focusing method for a digital camera to determine a focusing focal length that needs to be adjusted in an auto focusing stage.

2. Related Art

A user usually takes a picture with a digital camera in the following several stages. First, the digital camera is turned on; at this time, the digital camera enters a live view stage. Second, the user half presses a shutter after aiming at an object to be shot, and at the same time, the digital camera enters an auto focusing stage. Third, the user fully presses the shutter, and at this time, the digital camera enters a shooting stage and shoots the corresponding image picture.

The auto focusing stage refers to a focusing stage in which focusing is performed on the object to be shot and the shutter is not fully pressed for shooting. Briefly, it is a process in which the digital camera focuses on the object to be shot when the shutter is half pressed. During this process, a lens of the digital camera is moved to different focus positions (i.e., to different lens positions or steps, which are image sampling steps), and a degree of clarity or blur of the image is determined according to a focus value acquired at each lens position.

Conventional algorithms for determining a focusing focal length include a global search algorithm, a hill-climbing search algorithm, and a binary search algorithm. An effective search algorithm needs to consider the time required for search, the number of times for moving the lens, and search correctness. If too much search time is spent, the efficiency of auto focusing is lowered. If the lens is moved for too many times, additional battery power of the digital camera is consumed. On the contrary, the imaging quality of the digital camera is influenced.

For example, in the global search algorithm, a digital image acquired each time the lens is moved by one step is recorded; afterwards, a lens position corresponding to a digital image having the highest clarity is extracted; then, the lens is moved to the position corresponding to the highest clarity to achieve auto focusing, as shown in the diagram of a contrast value curve of FIG. 1.

Although the conventional art can find out an optimum focal length of the digital camera for the object to be shot precisely, the power consumption is a serious problem.

Especially, in the prior art, the digital camera performs focusing once again in the auto focusing stage after having performed a coarse focusing on an object to be shot in the live view stage; for two different objects to be shot close to each other in distance, the digital camera still needs to search from a shortest focal length to a longest focal length for the second object to be shot after shooting the first object; in addition, the digital camera cannot shoot a clear digital image if an object to be shot moves in the auto focusing stage. Thus, extra power is consumed, and the user cannot take pictures before the digital camera completes the adjustment.

### SUMMARY OF THE INVENTION

Accordingly, the present invention is a fast focusing method for a digital camera, suitable for the digital camera to judge whether a focusing focal length needs to be adjusted in an auto focusing stage.

In order to achieve the above objective, the present invention provides a fast focusing method for a digital camera, which comprises: capturing a target image at a reference focal length; performing a blur detection procedure on the target image to acquire a focus value; setting a focusing focal length range covering the reference focal length when the focus value is between a lower limit focusing threshold and an upper limit focusing threshold; capturing corresponding comparison images at different focusing focal lengths respectively in the focusing focal length range; calculating a contrast value of each comparison image; and calculating a target focal length based on the contrast values through a quadratic curve approximation method.

The blur detection procedure further comprises: setting at least one sampling area having a plurality of image pixels in the comparison image; comparing pixel values of every two of the adjacent image pixels in the sampling area respectively to obtain a plurality of contrast differences; accumulating the focus value if the contrast differences are greater than a preset threshold; and repeating the steps of calculation and accumulating the focus value until the steps are completed for all the image pixels in the sampling area.

In the present invention, it is judged whether refocusing needs to be performed on a captured digital image according to the captured digital image and a focal length thereof through a blur detection procedure. If a degree of clarity of an object to be shot in the digital image falls in a set threshold range, search does not need to be performed from the shortest focusing end to the longest focusing end. In this way, power consumption for moving the lens is effectively lowered, and focusing time of the digital camera is reduced.

### BRIEF DESCRIPTION OF THE DRAWINGS

The present invention will become more fully understood from the detailed description given herein below for illustration only, and thus are not limitative of the present invention, and wherein:

FIG. 1 is a diagram of a contrast value curve in the prior art;

FIG. 2 is an operation flow chart of a fast focusing procedure in the present invention;

FIG. 3 is a schematic architectural view of a digital camera to which the present invention is applicable;

FIG. 4 is a schematic flow chart of a first blur detection procedure in the present invention;

FIG. 5 is a schematic view of a sampling area in the present invention;

FIG. 6 is a schematic flow chart of a second blur detection procedure in the present invention;

FIG. 7A is a schematic view illustrating a process for selecting horizontally adjacent pixels in the present invention;

FIG. 7B is a schematic view illustrating a process for selecting vertically adjacent pixels in the present invention;

FIG. 7C is a schematic view illustrating a process for obtaining a focus value in the present invention;

FIG. 8 is a schematic flow chart of a third blur detection procedure in the present invention;

FIG. 9A is a schematic view of the edge of an image object in a preview image in the present invention;

FIG. 9B is a schematic view of the edge of an image object in a preview image in the present invention;

FIG. 9C is a schematic view of edge pixel selection in the present invention;

FIG. 10 is a schematic flow chart of a fourth blur detection procedure in the present invention; and

FIG. 11 is an operation timing diagram of the present invention.

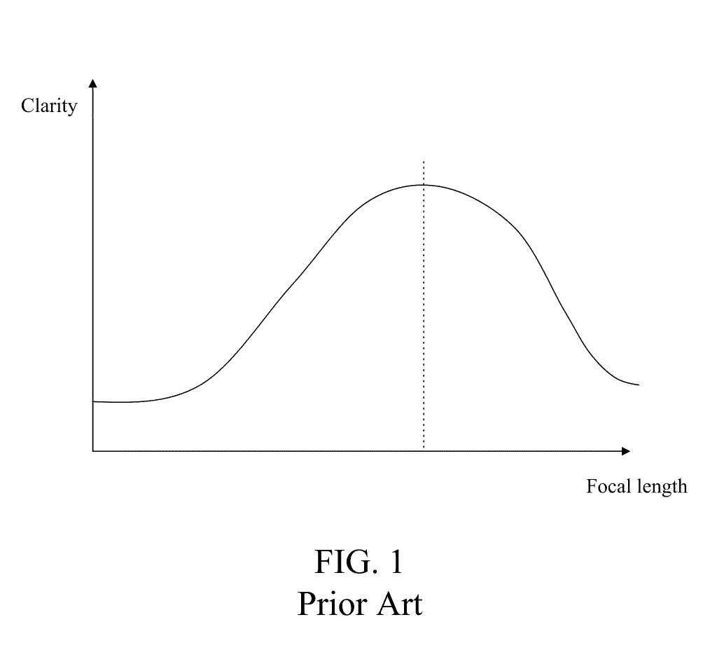

### DETAILED DESCRIPTION OF THE INVENTION

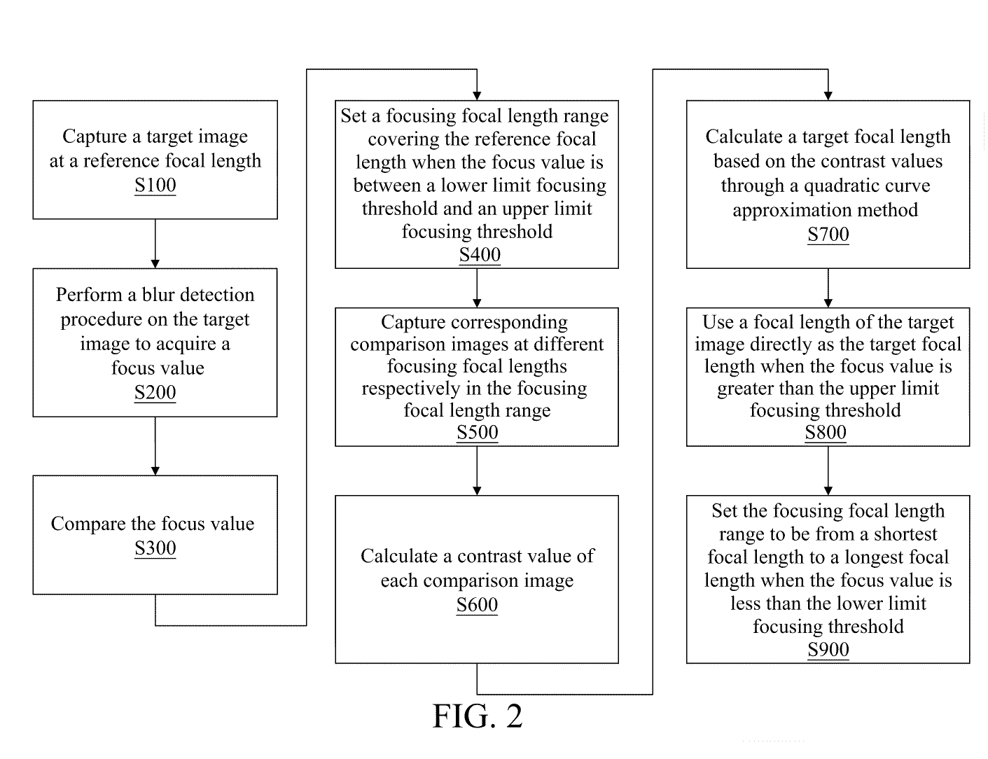

In the present invention, a digital camera adjusts a focusing focal length to a target focal length of an object to be shot rapidly in an auto focusing stage. It is judged whether a lens arrangement of a lens group needs to be readjusted according to a digital image captured by the digital camera, so as to obtain an optimal focusing focal length. FIG. 2 is an operation flow chart of a fast focusing procedure in the present invention. The fast focusing procedure comprises the following steps.

In Step S100, a target image is captured at a reference focal length.

In Step S200, a blur detection procedure is performed on the target image to acquire a focus value.

In Step S300, the focus value is compared.

In Step S400, when the focus value is between a lower limit focusing threshold and an upper limit focusing threshold, a focusing focal length range covering the reference focal length is set.

In Step S500, corresponding comparison images are captured at different focusing focal lengths respectively in the focusing focal length range.

In Step S600, a contrast value of each comparison image is calculated.

In Step S700, a target focal length is calculated based on the contrast values through a quadratic curve approximation method.

In Step S800, when the focus value is greater than the upper limit focusing threshold, a focal length of the target image is directly used as the target focal length.

In Step S900, when the focus value is less than the lower limit focusing threshold, the focusing focal length range is set to be from a shortest focal length to a longest focal length.

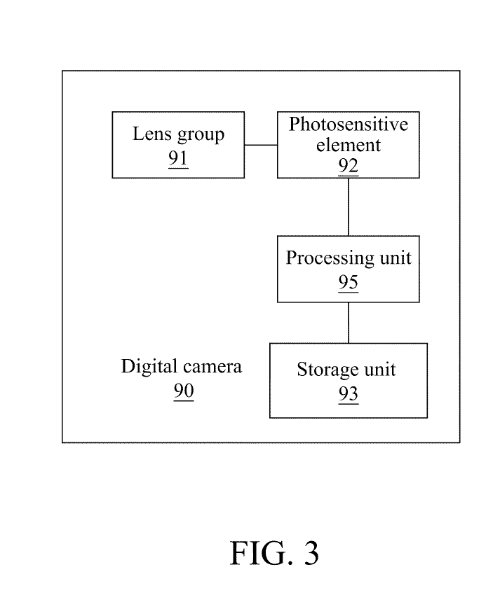

First, the digital camera captures a corresponding digital image at the reference focal length. Here, the digital image is defined as the target image. An operation mode of the present invention is further explained herein according to the following digital camera. The digital camera may be, but is not limited to, a digital camera shown in FIG. 3. In order to illustrate the method in the present invention more clearly, please refer to FIGS. 2 and 3 at the same time. FIG. 3 is a schematic architectural view of the digital camera to which the present invention is applicable. The digital camera 90 at least comprises a lens group 91, a photosensitive element 92, a storage unit 93, and a processing unit 95. The lens group 91 has a drive motor (not shown) and a plurality of lenses (not shown). The lens group 91 is used to adjust a focal length for shooting an object. The drive motor is used to adjust distances between the lenses so as to provide different focusing focal lengths. The photosensitive element 92 is connected to the lens group 91 and converts an image picture of a current scene into an electrical signal of a digital image. The photosensitive element 92 continuously transmits received image signals to the processing unit 95. The processing unit 95 is electrically connected to the photosensitive element 92 and the storage unit 93. The storage unit 93 is used to store digital images and the fast focusing procedure.

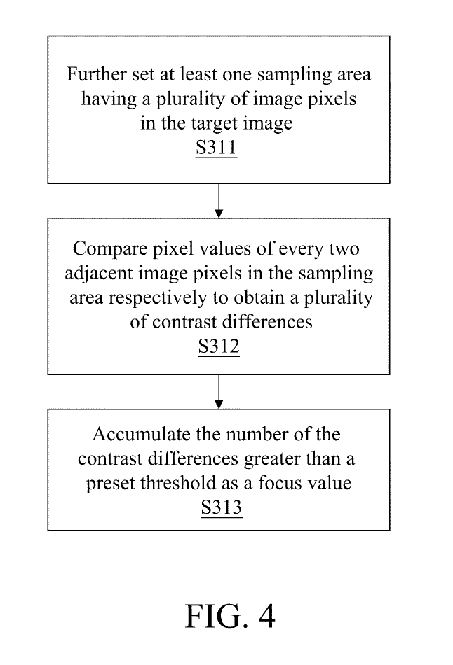

When Step S300 is performed, the processing unit 95 starts to perform the blur detection procedure on the digital image. FIG. 4 is a schematic view of an implementation aspect of a first blur detection procedure in the present invention.

In Step S311, at least one sampling area having a plurality of image pixels is further set in the target image.

In Step S312, pixel values of every two adjacent image pixels in the sampling area are compared respectively to obtain a plurality of contrast differences.

In Step S313, the number of the contrast differences greater than a preset threshold is accumulated as a focus value.

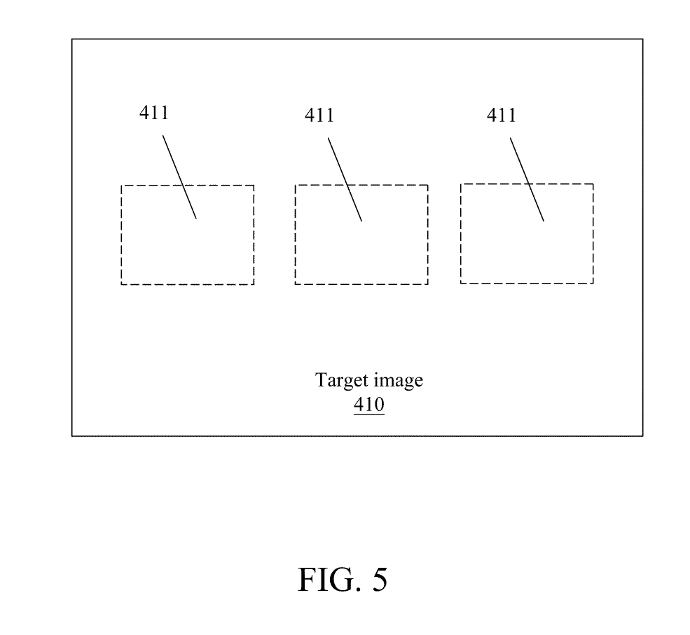

It should be noted that, each of the contrast differences generated in Step S312 is obtained by calculating every two adjacent image pixels of all the image pixels in the sampling area. FIG. 5 is a schematic view of the sampling area. Referring to FIG. 5, at least one sampling area is further defined in the target image 410. The sampling area may be, but is not limited to, the entire target image 410, and may also be a focusing frame 411 at a preset fixed position or a face focusing frame 411 produced after face detection. A plurality of focusing frames 411 is set in the digital camera 90 and distributed at fixed positions in the target image 410. The focusing frame 411 is used to provide a reference position for the digital camera 90 to focus on a scene to be shot.

When the digital camera 90 sets the focusing frame 411 thereof to be the focusing frame 411 in the center, the digital camera 90 performs focusing and comparison on the focusing frame 411 in the center. Similarly, the focusing frames 411 in other areas and positions also provide the same function. The face focusing frame 411 is the corresponding focusing frame 411 produced according to a face area judged by the digital camera 90. If a plurality of face focusing frames 411 appears at the same time, in this implementation aspect of the present invention, it is assumed that the face focusing frame 411 having the shortness focal length is taken as the sampling area for judgment, but the present invention is not limited thereto. In other words, the face focusing frame 411 closest to the digital camera 90 is taken as the sampling area.

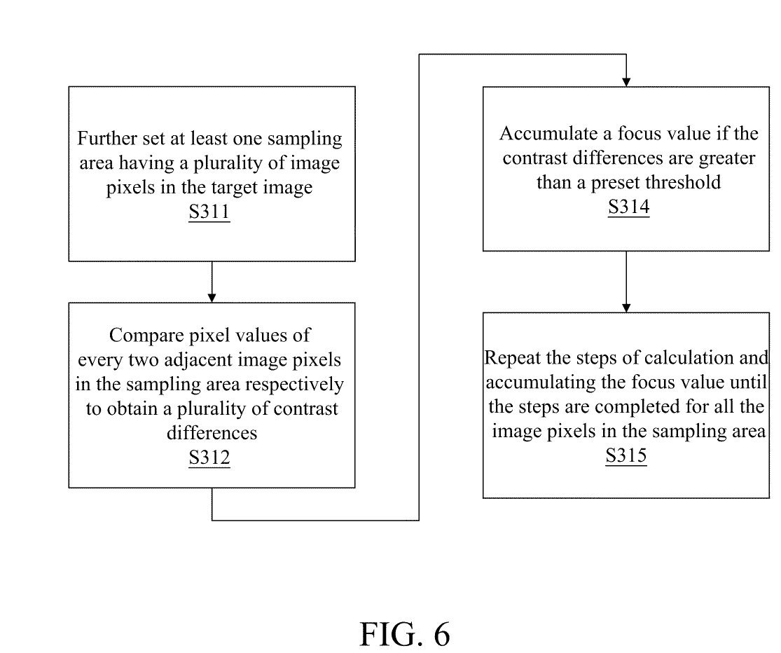

In the first implementation aspect, all the contrast differences are calculated, and then the focus value is accumulated. In addition to this, the accumulating step in Step S313 may also be changed to a step of judging whether to accumulate the focus value each time the calculation of the comparison difference is completed. This operation process is shown in FIG. 6.

The second implementation aspect comprises the following steps.

In Step S311, at least one sampling area having a plurality of image pixels is further set in the target image.

In Step S312, pixel values of every two adjacent image pixels in the sampling area are compared respectively to obtain a plurality of contrast differences.

In Step S314, if the contrast differences are greater than a preset threshold, a focus value is accumulated.

In Step S315, the steps of calculation and accumulating the focus value are repeated until the steps are completed for all the image pixels in the sampling area.

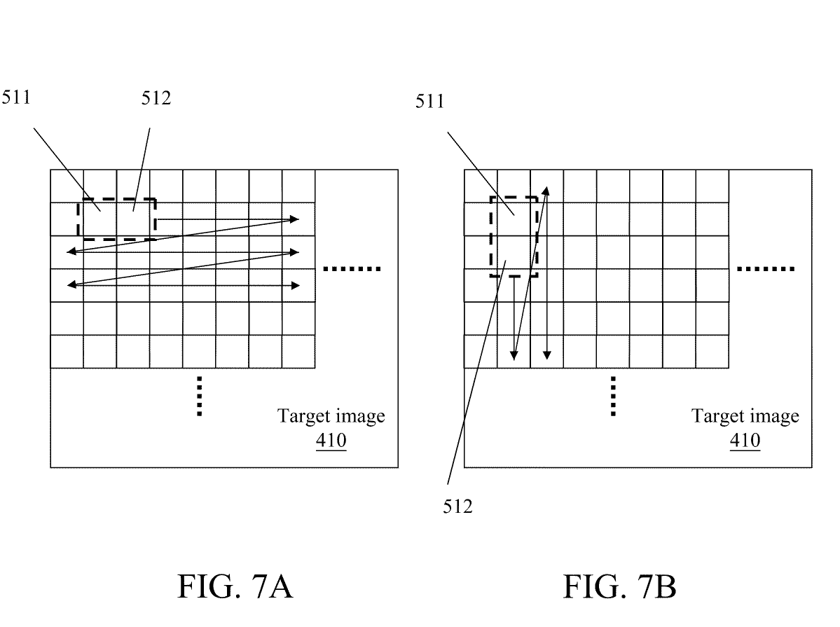

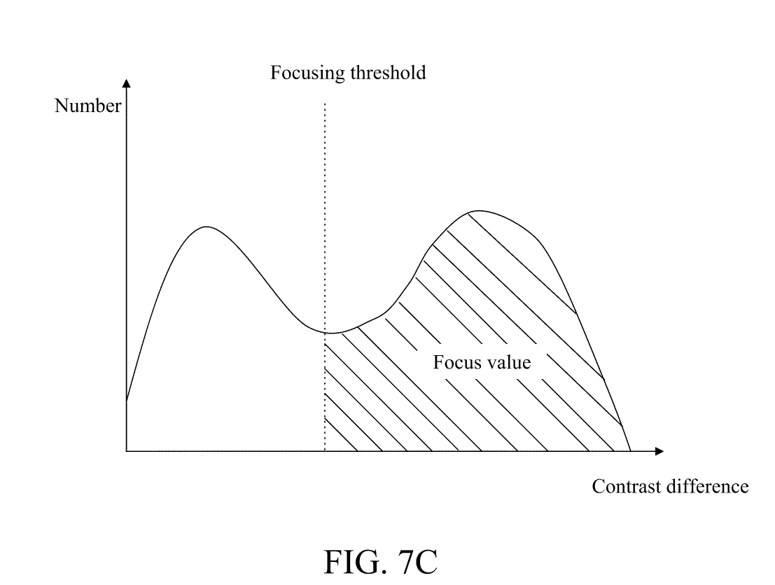

In the process for calculating the contrast differences in Step S312 in the first implementation aspect and the second implementation aspect, two adjacent image pixels are respectively selected for processing. Here, an image pixel to be compared is defined as a target pixel 512, and another adjacent pixel that is selected is defined as a comparison pixel 511. The selection of the comparison pixel 511 may be selecting a pixel horizontally or vertically adjacent to the target pixel. The target pixel 512 may be selected sequentially according to a pixel arrangement in the sampling area. For example, if a pixel set in the sampling area is a two-dimensional array (it is assumed that the pixel set is a pixel_array[m][n] pixel array), the target pixel 512 is selected by moving one by one from a position having a minimum serial number (i.e., pixel_array[0][0]) to a position having a maximum serial number (i.e., pixel_array[0][n−1]) of the array. After the movement is completed for all pixels in each row, it is performed from the current row to a next row, as shown by arrows in FIG. 7A. The comparison pixel 511 may be selected from a next pixel (in a horizontal direction or vertical direction) of the target pixel 512. FIGS. 7A and 7B are respectively schematic views illustrating a process for selecting horizontally adjacent pixels and vertically adjacent pixels. Then, the comparison pixel 511 is subtracted from the selected target pixel 512 so as to produce a contrast difference corresponding to the target pixel 512. Afterwards, other target pixels 512 are selected sequentially from the target image 410, and corresponding contrast differences are calculated. Finally, the number of comparison differences greater than the preset threshold in all the obtained contrast differences is calculated, and the calculated number is used as the focus value. If observations are made through a statistical diagram, FIG. 7C is taken as an example. In FIG. 7C, the horizontal axis represents the contrast difference, the longitudinal axis represents the number, and the focus value is an area of the oblique line area in the right of FIG. 7C.

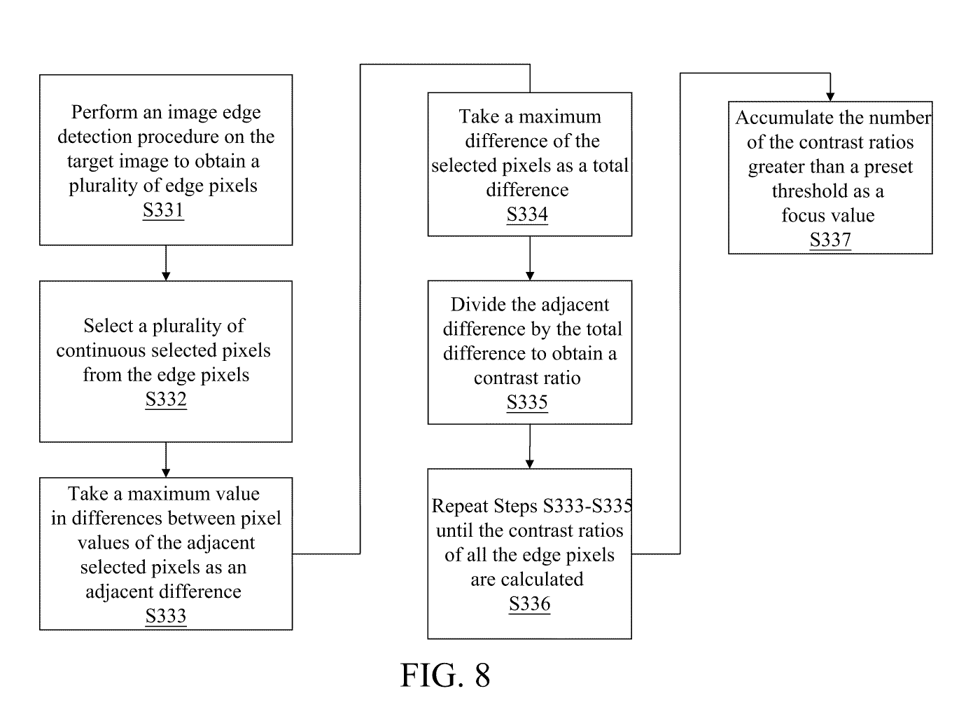

In addition to the above steps, the blur detection procedure may further be performed in the following variations. FIG. 8 is a schematic view of an implementation aspect of a third blur detection procedure in the present invention. The blur detection procedure comprises the following steps.

In Step S331, an image edge detection procedure is performed on the target image to obtain a plurality of edge pixels.

In Step S332, a plurality of continuous selected pixels is selected from the edge pixels.

In Step S333, a maximum value in differences between pixel values of the adjacent selected pixels is taken as an adjacent difference.

In Step S334, a maximum difference of the selected pixels is taken as a total difference.

In Step S335, the adjacent difference is divided by the total difference to obtain a contrast ratio.

In Step S336, Steps S333-S335 are repeated until the contrast ratios of all the edge pixels are calculated.

In Step S337, the number of the contrast ratios greater than a preset threshold is accumulated as a focus value.

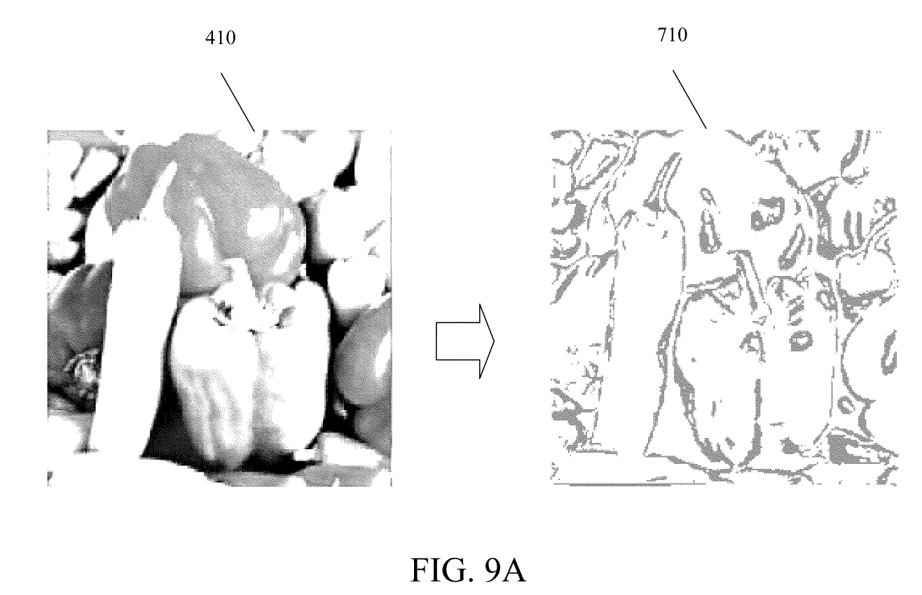

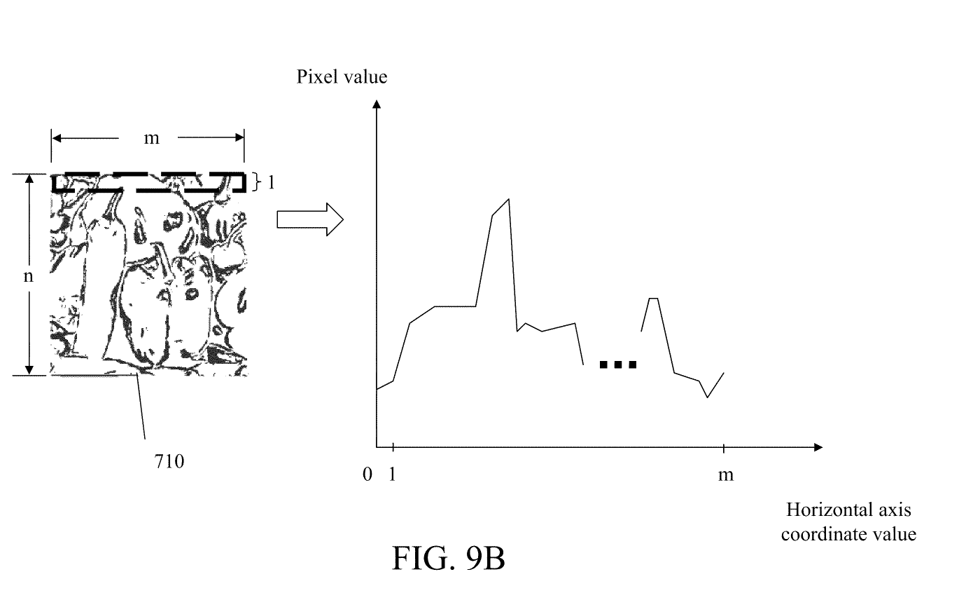

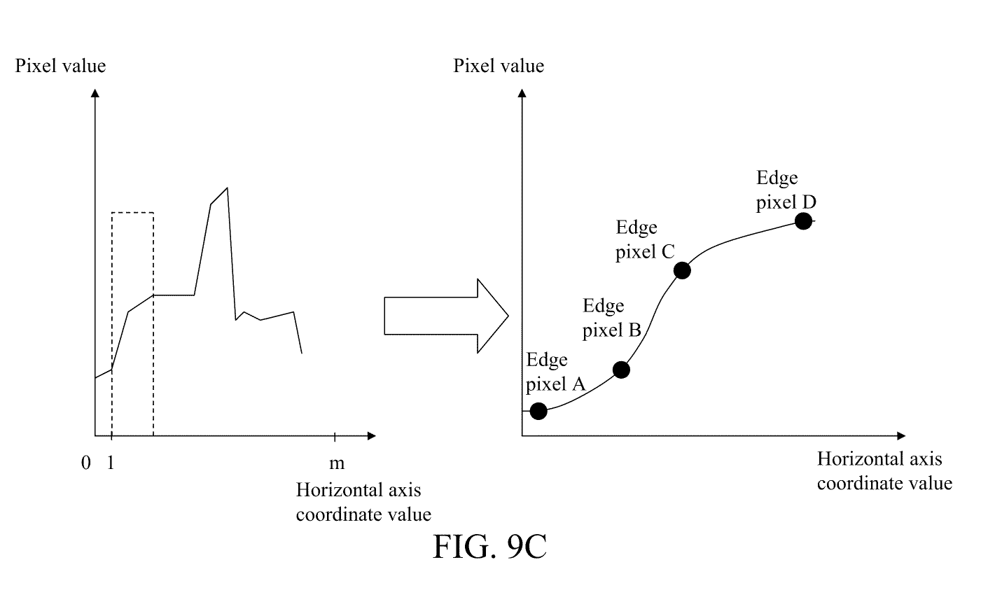

The target image 410 is processed through the image edge detection procedure to produce a corresponding edge image 710. The edge detection algorithm described in the present invention may be a Sobel edge detection algorithm, a Dijkstra's algorithm, a Canny edge detection algorithm, or the like. FIG. 9A is a schematic view of the edge of an image object in the target image.

Referring to FIG. 9B, pixel values of the edge image 710 are read sequentially in a row major/column major mode so as to produce a corresponding gray scale distribution curve. For example, if the edge image 710 is deemed as a two-dimensional array (for example, the edge image 710 is deemed as a pixel_array[m][n] pixel array), pixel values, i.e., pixel_array[0][x], x={0, 1 . . . , n−1}, are read sequentially from the first row of the edge image 710 in the row major mode, and pixel values and positions of the read pixel values are respectively recorded in a gray scale distribution curve. After the pixel values of the first row of the edge image 710 are read, a gray scale distribution curve corresponding to the first row is output, and reading is performed on other rows in other edge images 710 for corresponding gray scale distribution curves. In addition to this, reading for the gray scale distribution curves may also be performed in the column major mode.

Then, a segment having a pixel variation exceeding a variation threshold is selected from the gray scale distribution curve, and is defined as an edge segment. A plurality of edge pixels is selected from the edge segment. FIG. 9C is taken as an example for illustration, in which four edge pixels A, B, C, and D (an area circled by a dashed line in FIG. 9C) exist. Every two adjacent edge pixels are selected successively. Here, each group of contrast distribution values is defined as an edge pixel set. Therefore, the edge pixels may be divided into three edge pixel sets (A,B), (B,C), and (C,D) and a total pixel set (A,D). Each edge pixel set correspondingly has a respective difference, and the total pixel set also has a total difference. An edge pixel set having a maximum difference is selected from the three edge pixel sets, and the selected set having the maximum difference is divided by the total difference to obtain a contrast ratio. In this implementation aspect, (X,Y) is an absolute value of a value obtained by subtracting an X pixel value from a Y pixel value. Refer to the following Formula 1:

Max((A,B),(B,C),(C,D))/(D,A) (Formula 1)

The following example is taken herein for illustration. It is assumed that four pixels A=38, B=46, C=68, and D=82 are selected from the edge segment. The edge pixel sets are respectively (A, B), (B, C), and (C, D), which are respectively (A, B)=8, (B, C)=22, and (C, D)=14, and the total difference is (A, D)=44. A maximum value of the three edge pixel sets is 22, so that the adjacent difference is (B, C), and thus the contrast ratio is 22/44=0.5.

If only two pixels exist in the edge segment, a difference of this edge segment is not calculated, because this would cause the contrast ratio of this edge segment to become 1 so that whether the edge segment is an edge of the image object cannot be judged accurately. After this edge segment is calculated, the calculation of other edge segments in the gray scale distribution curve is continued to obtain the rest differences. Then, comparison is performed on the differences to determine whether they are greater than the preset threshold after the differences are obtained. The number of all the differences greater than the present threshold is calculated, and the accumulated number is defined as the focus value.

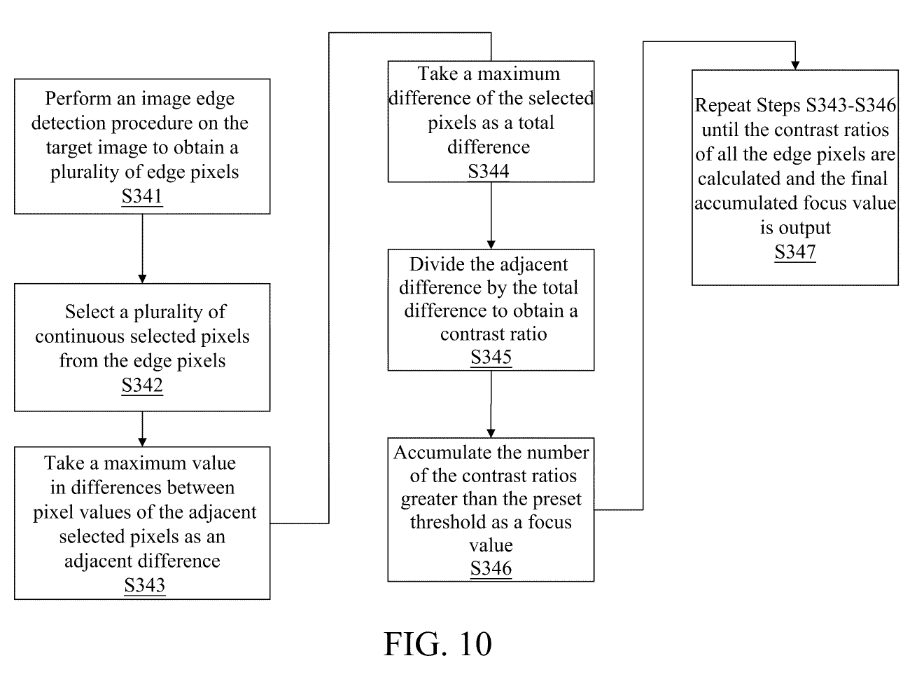

Different from the third implement aspect in which the focus value is not accumulated until all the contrast ratios are accumulated, the fourth implementation aspect also first calculates contrast ratios one by one, judges whether the produced contrast ratio is greater than the preset threshold, and repeats this step until all the contrast ratios are calculated. FIG. 10 is another schematic operation flow chart of the fourth implementation aspect.

In Step S341, an image edge detection procedure is performed on the target image to obtain a plurality of edge pixels.

In Step S342, a plurality of continuous selected pixels is selected from the edge pixels.

In Step S343, a maximum value in differences between pixel values of the adjacent selected pixels is taken as an adjacent difference.

In Step S344, a maximum difference of the selected pixels is taken as a total difference.

In Step S345, the adjacent difference is divided by the total difference to obtain a contrast ratio.

In Step S346, the number of the contrast ratios greater than the preset threshold is accumulated as a focus value.

In Step S347, Steps S343-S346 are repeated until the contrast ratios of all the edge pixels are calculated and the final accumulated focus value is output.

After the focus value is obtained, the processing unit 95 performs comparison according to relationships between the focus value, a lower limit focusing threshold, and an upper limit focusing threshold. When the focus value falls between the lower limit focusing threshold and the upper limit focusing threshold, the processing unit 95 sets a focusing focal length range covering the reference focal length. In the present invention, the reference focal length is set to be the longest focal length of the focusing focal length range. In a similar way, the reference focal length may also be set to be the shortest focal length of the focusing focal length range or set to be in the focusing focal length range.

When focusing on an object to be shot, the digital camera 90 will adjust from the shortest focal length of the focusing focal length range to the longest focal length of the focusing focal length range, and performs Steps S500 and S600 to obtain the contrast value of each comparison image during the movement. Since the distribution of the contrast values may form a curve, the processing unit 95 may find out a maximum contrast value from the contrast values through a quadratic curve approximation method, and define a focal length corresponding to the found contrast value as a target focal length. The quadratic curve approximation method may be realized through a Simpson method, a Newton method, or other algorithms.

In the present invention, for example, three digital images are captured in the focusing focal length range in the following description. Any variation made by persons skilled in the art to the number of the captured digital images shall fall within the scope of the present invention. Then, the processing unit 95 records focusing information of each digital image. Finally, a focal length corresponding to the found maximum focusing information is set as the target focal length of the object to be shot, and the focal length of the lens is adjusted to this focal length. In this way, the digital camera 90 does not need to move between the original longest focusing focal length and shortest focusing focal length. Thus, the movement of lenses in the lens group 91 can be effectively reduced, thereby enhancing the focusing speed of the digital camera 90 and lowering the power consumption of the digital camera 90.

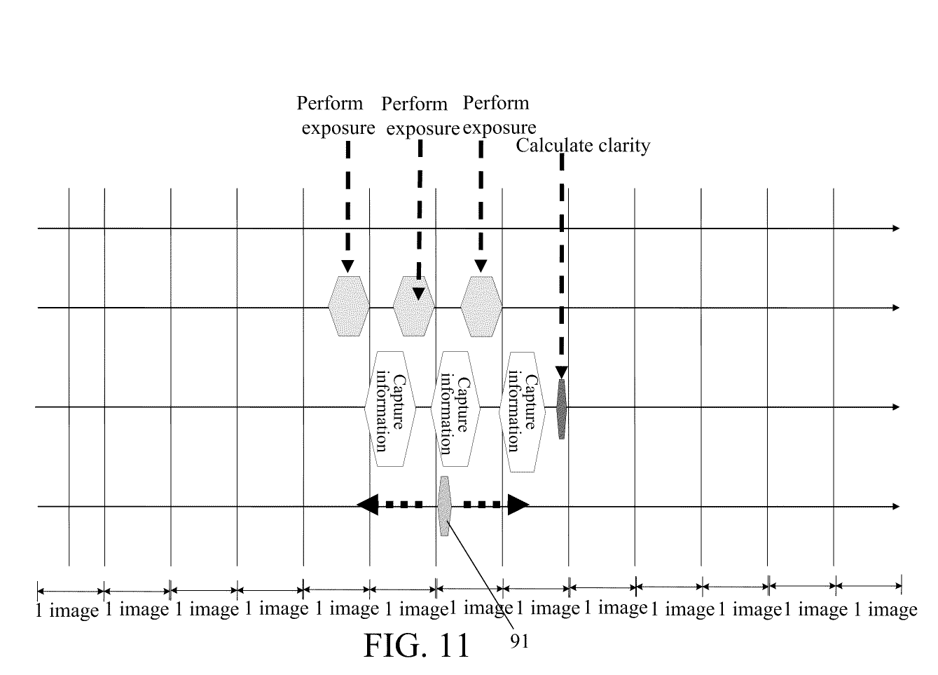

In order to further illustrate the digital camera and the operation of the present invention, refer to FIG. 11, which is an operation timing diagram of the present invention. In FIG. 11, the horizontal axis represents a time interval for capturing digital images, and the longitudinal axis represents, from up to down, a time point for exposure, a time point for loading shooting information (for example, an exposure value, an aperture, photosensitivity, or the like) of the image, a time point for calculating the focus value, and a time point for determining to move the lenses respectively. After calculating the focus value, the processing unit 95 determines the position to which the lenses are moved according to the calculation result.

Finally, after the fast focusing procedure is completed, corresponding processing procedures are provided not only for the case that the focus value falls between the upper limit focusing threshold and the lower limit focusing threshold, but also for the case that the focus value is at different focusing thresholds in the implementation aspects of the present invention. If the focus value is greater than the upper limit focusing threshold, it indicates that the current focal length is the focusing focal length most suitable for the object to be shot, and thus the digital camera 90 does not need to readjust the focusing focal length. If the focus value is less than the lower limit focusing threshold, it indicates that the focusing focal length of the digital camera 90 does not fall on the object to be shot, and thus the digital camera 90 needs to readjust the focusing focal length. The digital camera 90 moves from the shortest focal length to the longest focal length and acquires corresponding images at different focal lengths, finds out the clearest image from the acquired images, and determines that a focal length of this image is the target focal length.

In the present invention, it is judged whether refocusing needs to be performed on a captured digital image according to the captured digital image and a focal length thereof through a blur detection procedure. If a degree of clarity of an object to be shot in the digital image falls in a set threshold range, search does not need to be performed from the shortest focusing end to the longest focusing end. In this way, the power consumption of moving the lens is effectively lowered, and the focusing time of the digital camera is reduced.

What is claimed is:

1. A fast focusing method for a digital camera, applied in the digital camera for adjusting a focusing focal length of the digital camera to a target focal length in an auto focusing stage, the focusing method comprising:
capturing a target image at a reference focal length;
performing a blur detection procedure on the target image to acquire a focus value;
setting a focusing focal length range covering the reference focal length when the focus value is between an upper limit focusing threshold and a lower limit focusing threshold;
capturing corresponding comparison images at different focusing focal lengths respectively in the focusing focal length range;
calculating a contrast value of each of the comparison images; and
calculating the target focal length based on the contrast values through a quadratic curve approximation method.

2. The fast focusing method for the digital camera according to claim 1, wherein at least three of the comparison images having different focusing focal lengths are captured in the focusing focal length range.

3. The fast focusing method for the digital camera according to claim 1, wherein the blur detection procedure comprises:
setting at least one sampling area in the comparison image, wherein the sampling area has a plurality of image pixels;
comparing pixel values of every two of the adjacent image pixels in the sampling area respectively to obtain a plurality of contrast differences; and
accumulating a number of the contrast differences greater than a preset threshold as the focus value.

4. The fast focusing method for the digital camera according to claim 1, wherein the blur detection procedure comprises:
setting at least one sampling area in the comparison image, wherein the sampling area has a plurality of image pixels;
comparing pixel values of every two of the adjacent image pixels in the sampling area respectively to obtain a plurality of contrast differences; and
accumulating the focus value if the contrast differences are greater than a preset threshold; and
repeating the steps of calculation and accumulating the focus value until the steps are completed for all the image pixels in the sampling area.

5. The fast focusing method for the digital camera according to claim 1, wherein the blur detection procedure comprises:
performing an image edge detection procedure to find out a plurality of edge pixels of an image object of the comparison image;
calculating a plurality of contrast ratios of the edge pixels sequentially; and
accumulating a number of the contrast ratios greater than a preset threshold as the focus value;
wherein the step of calculating the plurality of contrast ratios of the edge pixels sequentially comprises:
selecting a plurality of continuous selected pixels from the edge pixels;
taking a maximum value in differences between pixel values of the adjacent selected pixels as an adjacent difference;
taking a maximum difference of the selected pixels as a total difference;
dividing the adjacent difference by the total difference to obtain the contrast ratio; and
repeating the above four steps until the contrast ratios of all the edge pixels are calculated.

6. The fast focusing method for the digital camera according to claim 1, wherein the blur detection procedure comprises:
performing an image edge detection procedure to find out a plurality of edge pixels of an image object of the comparison image;
calculating a contrast ratio of each of the edge pixels sequentially;
repeating the above steps until the contrast ratios of all the edge pixels are calculated; and
accumulating a number of the contrast ratios greater than a preset threshold as the focus value;
wherein the step of calculating the contrast ratio of each of the edge pixels comprises:
selecting a plurality of selected pixels for one of the edge pixels;
taking a maximum value in differences between pixel values of the adjacent selected pixels as an adjacent difference;
taking a maximum difference of the selected pixels as a total difference; and
dividing the adjacent difference by the total difference to obtain the contrast ratio.

7. The fast focusing method for the digital camera according to claim 1, wherein when the focus value is greater than the upper limit focusing threshold, a focal length of the target image is directly used as the target focal length.

8. The fast focusing method for the digital camera according to claim 1, wherein when the focus value is less than the lower limit focusing threshold, the focusing focal length range is set to be from a shortest focal length to a longest focal length.
